(19) United States
(12) Patent Application Publication
(10) Pub. No.: US 2006/0218176 A1
(43) Pub. Date: Sep. 28, 2006

(54) System, method, and service for organizing data for fast retrieval

(75) Inventors: Windsor Wee Sun Hsu, San Jose, CA (US); Shauchi Ong, San Jose, CA (US); Qingbo Zhu, Urbana, IL (US)

Correspondence Address: SAMUEL A. KASSATLY LAW OFFICE, 20690 VIEW OAKS WAY, SAN JOSE, CA, 95120, US

(73) Assignee: International Business Machines Corporation

(21) Appl. No.: 11/089,599

(22) Filed: Mar. 24, 2005

(51) Int. Cl. G06F 17/00

(52) U.S. Cl. 707/102

(57) ABSTRACT

A data organization system includes an index that offers fast retrieval of records and that protects records from logical modification. The index includes a balanced tree that grows from the root of the tree down to the leaves and requires no re-balancing. Each level in the tree includes a hash table. The hash table in each level in the tree can use a hash function that is different and independent from the hash function used in any other level in the tree. Alternatively, the hash table in each level in the tree can use a universal hash function. Possible locations of a record in the tree are fixed and determined by a hash function of a key of that record.

### FIELD OF THE INVENTION

The present invention generally relates to indexing records. More particularly, the present invention pertains to a scalable method of indexing records that does not require adjustment to the index structure. When used with WORM storage, the present invention ensures that an index entry for a record and a path to the index entry are immutable and a path to the record is determined by the record.

### BACKGROUND OF THE INVENTION

Records such as electronic mail, financial statements, medical images, drug development logs, quality assurance documents, and purchase orders are valuable assets to a business that owns those records. The records represent much of the data on which key decisions in business operations and other critical activities are based. Having records that are accurate and readily accessible is vital to the business.

Records also serve as evidence of activity. Effective records are credible and accessible. Given the high stakes involved in maintaining the integrity of records, tampering with records can yield huge gains. Consequently, tampering with records must be specifically guarded against. Increasingly, records are stored in electronic form, making the records relatively easy to delete and modify without leaving a trace. Ensuring that these records are trustworthy, that is credible and irrefutable, is particularly imperative.

A growing fraction of records maintained by businesses or other organizations is subject to regulations that specify proper maintenance of the records to ensure the trustworthiness of records. The penalties for failing to comply with the regulations can be severe. Regulatory bodies such as the Securities Exchange Commission (SEC) and the Food and Drug Administration (FDA) have recently levied unprecedented fines for non-compliance with these records maintenance regulations. Bad publicity and investor flight as a result of findings of non-compliance cost businesses or organizations even more. As information becomes more valuable to organizations, the number and scope of such records keeping regulations is likely to increase.

A key requirement for trustworthy record keeping is ensuring that in a records review such as, for example, an audit, a legal or regulatory discovery, an internal investigation, all records relevant to the review can be quickly located and retrieved in an unaltered form. Consequently, records require protection during storage from any modification such as, for example, selective alteration and destruction. Modification of records can result from software bugs and user errors such as issuing a wrong command or replacing the wrong storage disk. Furthermore, records require protection from intentional attacks mounted by adversaries such as disgruntled employees, company insiders, or conspiring technology experts.

In addition, when records expire, i.e., they have outlived their usefulness to an organization and have passed any mandated retention period, it is crucial for the records to be disposed. Disposition of records includes deleting the records and, in some cases, ensuring that the records cannot be recovered or discovered even with the use of data forensics.

One conventional technique for maintaining the trustworthiness of records includes a write-once-read-many (WORM) storage device. However, while WORM storage helps in the preservation of electronic records, WORM storage alone cannot ensure the trustworthiness of electronic records, especially with the increasingly large volume of records that have to be maintained. Specifically, some form of direct access mechanism such as an index is required to ensure that all records relevant to an inquiry can be discovered and retrieved in a timely fashion.

One conventional approach maintains an index in rewritable storage. Another conventional approach stores an index in WORM storage using conventional indexing techniques for WORM storage. These techniques include variations of maintaining a balanced index tree by adjusting the tree structure to bring it into balance as needed (e.g., persistent search tree), growing an index tree from the leaves of the tree up (e.g., write-once B-tree), and scaling up an index by relocating index entries (e.g., dynamic hashing). Conventional indexing techniques, however, are designed primarily for storage and operational efficiency rather than trustworthy record keeping.

If an index allows a previously written index entry to be effectively modified, then records, even those stored in WORM storage, can in effect be hidden or altered. For example, an adversary intent on unauthorized modification of records in WORM storage can create a new record to replace an older record, and modify the index entry that accesses the old record to access the new record. The old record still exists in the WORM storage, but cannot be accessed through the index because the index now points to the new record. An adversary can also logically delete a record or perform other forms of record hiding by similarly manipulating the index.

What is therefore needed is a system, a service, a computer program product, and an associated method for organizing data for fast retrieval that eliminates exposure of an index to manipulation by an adversary, insuring that once a record is committed to storage, the record cannot be hidden or otherwise altered. The system should be scalable to extremely large collections of records while maintaining acceptable space overhead. Furthermore, records should be quickly accessible through the system. The need for such a solution has heretofore remained unsatisfied.

### SUMMARY OF THE INVENTION

The present invention satisfies this need, and presents a system, a service, a computer program product, and an associated method (collectively referred to herein as “the system” or “the present system”) for organizing data for fast retrieval. The present system is a statistically balanced tree that grows from the root of the tree down and requires no re-balancing. Each level in the tree includes a hash table.

In one embodiment, the hash table in each level in the tree uses a hash function that is different and independent from the hash function used in any other level in the tree. In another embodiment, the hash table in each level in the tree uses a universal hash function. The present system represents a family of hash trees. By varying parameters and choosing different hash functions, the present system produces trees with different characteristics. Exemplary trees of the present system include a thin tree, a hash trie, a fat tree, and a multi-level hash table.

The present system includes a tree, an insertion module, and a retrieval module. The insertion module inserts a record and the retrieval module looks up a record beginning at a root node of the tree. If unsuccessful, the insertion or lookup of the record is repeated at one or more of the children subtrees of the root node. When a record cannot be inserted into any of the existing nodes, a new node is created and added to the tree as a leaf. At each level, possible locations for inserting the record are determined by a hash of the record key. Consequently, possible locations of a record in the tree are fixed and determined solely by that record. Moreover, inserted records are not rehashed or relocated.

In one embodiment, the index of the present system is stored in WORM storage. The present system includes an index that prevents logical modification of records. The present system ensures that once a record is preserved in storage such as, for example, WORM storage, the record is accessible in an unaltered form and in a timely fashion. While the present system is described for illustration purposes only in terms of WORM storage, it should be clear that the present system is applicable to any type of storage.

Once a record is committed, the present system ensures that the index entry for that record and the path to the index entry are immutable. The path to an index entry includes the sequence of tree nodes beginning at the root that are traversed to locate the index entry.

The insertion of a new record in the present system does not affect access to previously inserted records through the index. Once the insertion of a record into the index has been committed to WORM storage, the record is guaranteed to be accessible through the index unless the WORM storage is compromised. In other words, the record is guaranteed to be accessible through the index unless data stored in the WORM storage can be modified.

The present system supports incremental growth of the index. The present system further scales to extremely large collections of records, supporting a rapidly growing volume of records.

The present system exhibits acceptable space overhead. Rapid improvement in disk aerial density has made storage relatively expensive. However, storage efficiency is still an important consideration, especially since storage required to satisfy intense regulatory scrutiny applied to some records storage situations tends to be considered overhead.

The present system further supports selective disposition of index entries to ensure that expired records cannot be recovered or reconstituted from index entries. Records typically have an expiration date after which the records can be disposed. To prevent reconstruction of records that have been disposed, index entries pointing to the records also require disposition. In some cases, the expired records and index entries have to be “shredded” so that the records cannot be recovered or reconstituted from the index entries even with the use of data forensics.

However, the smallest unit of disposition (e.g., sector, object, disc) is typically larger than an index entry. In one embodiment, each record includes an expiration date. As the present system inserts a record in a tree, an index entry corresponding to the record is stored in a “disposition unit” together with index entries associated with records having similar or equivalent expiration dates. As the records expire and are disposed, the “disposition unit” is disposed, thereby allowing disposition of only those index entries associated with records that have been disposed.

The present system can be used for any trusted means of finding and accessing a record. Examples of such include a file system directory that allows records (files) to be located by a file name, a database index that enables records to be retrieved based on a value of some specified field or combination of fields, and a full-text index that allows finding of records (documents) including a particular word or phrase.

The present invention may be embodied in a utility program such as a data organization utility program. The present invention also provides means for the user to identify a records source or set of records for organization, select a set of requirements, and then invoke the data organization utility program to organize access to the records source or set of records. The set of requirements includes an index tree type and one or more performance and cost objectives.

### BRIEF DESCRIPTION OF THE DRAWINGS

The various features of the present invention and the manner of attaining them will be described in greater detail with reference to the following description, claims, and drawings, wherein reference numerals are reused, where appropriate, to indicate a correspondence between the referenced items, and wherein:

FIG. 1 is a schematic illustration of an exemplary operating environment in which a data organization system of the present invention can be used;

FIG. 2 is a block diagram of the high-level architecture of the data organization system of FIG. 1;

FIG. 3 is a process flow chart illustrating a method of operation of the data organization system of FIGS. 1 and 2 in inserting a record into a tree;

FIG. 4 is comprised of FIGS. 4A, 4B, and 4C and represents a diagram of a tree illustrating a process of the data organization system of FIGS. 1 and 2 in inserting a record into a tree;

FIG. 5 is a process flow chart illustrating a method of operation of the data organization system of FIGS. 1 and 2 in retrieving a record in a tree;

FIG. 6 is a diagram of a thin tree configuration of the data organization system of FIGS. 1 and 2;

FIG. 7 is a diagram of a fat tree configuration of the data organization system of FIGS. 1 and 2; and

FIG. 8 is a diagram of a multi-level hash table configuration of the data organization system of FIGS. 1 and 2.

### DETAILED DESCRIPTION OF PREFERRED EMBODIMENTS

The following definitions and explanations provide background information pertaining to the technical field of the present invention, and are intended to facilitate the understanding of the present invention without limiting its scope:

Record: an item of data such as a document, file, image, etc.

Index entry: an entry in the index that includes a key of a record and a pointer to the record.

Bucket: an entry in a tree node used to store a record or the index entry of a record.

Growth Factor kᵢ: represents a size to which a level in the tree can grow. Level (i+1) can include kᵢ times the number of buckets as level i. The growth factor may vary for each level. Let K={k₀,k₁,k₂, . . . } where kᵢ is the growth factor for level i.

H: a group of universal hash functions with one hash function used for each level in a tree. Each of the hash functions in H is independent, efficient to calculate, and insensitive to the size of hash tables. H uniquely determines how a tree links a node with the children of the node, i.e., the construction of the tree. Let H={h₀, h₁, h₂, . . . } denote a set of hash functions where hᵢ is the hash function for level i.

Tree node: a storage allocation unit in the present system. The sizes of tree nodes at different levels may be similar or different, depending on the type of tree. Let M={m₀,m₁,m₂, . . . } where mᵢ denotes the size of a tree node at level i, i.e., the number of buckets a tree node at level i contains.

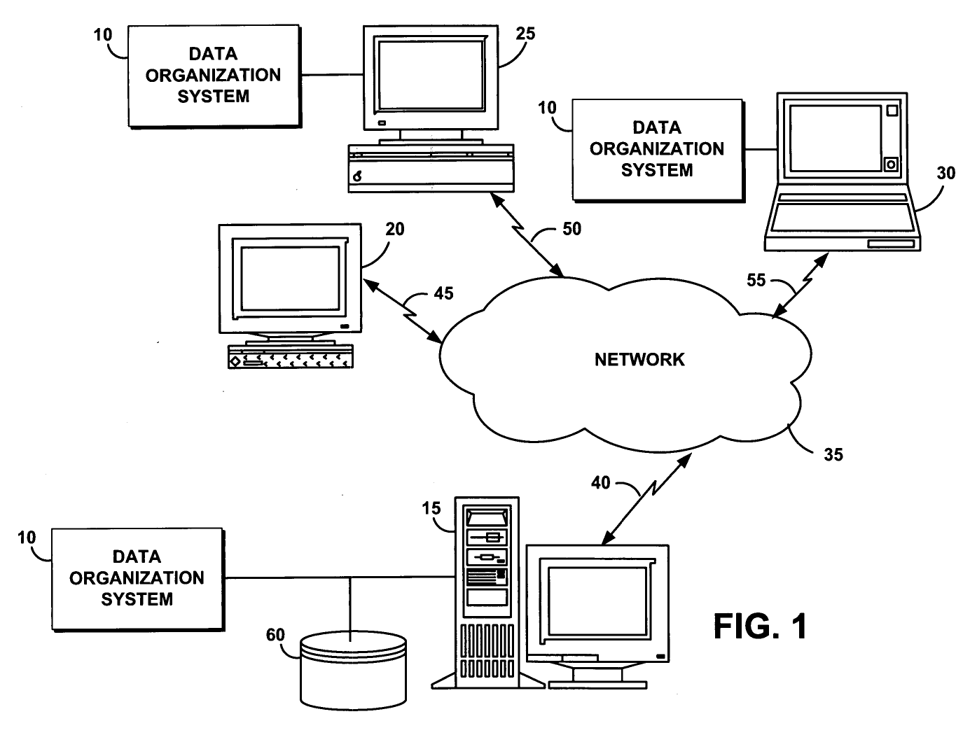

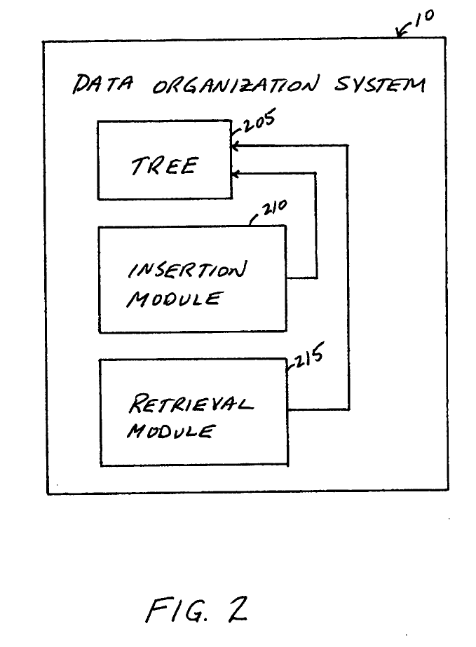

FIG. 1 portrays an exemplary overall environment in which a system, a service, a computer program product, and an associated method for organizing data for fast retrieval (the “data organization system 10” or the “system 10”) according to the present invention may be used. System 10 includes a software programming code or a computer program product that is typically embedded within, or installed on a host server 15. Alternatively, system 10 can be saved on a suitable storage medium such as a diskette, a CD, a hard drive, or like devices.

Users, such as remote Internet users, are represented by a variety of computers such as computers 20, 25, 30, and can access the host server 15 through a network 35. Computers 20, 25, 30 each include software that allows the user to interface securely with the host server 15. The host server 15 is connected to network 35 via a communications link 40 such as a telephone, cable, or satellite link. Computers 20, 25, 30, can be connected to network 35 via communications links 45, 50, 55, respectively. While system 10 is described in terms of network 35, computers 20, 25, 30 may also access system 10 locally rather than remotely. Computers 20, 25, 30 may access system 10 either manually, or automatically through the use of an application.

System 10 organizes data stored on a storage device 60. Alternatively, system 10 organizes data stored within the structure of system 10. System 10 includes a storage device for storing an index. Alternatively, system 10 stores an index on storage device 60 or some other storage device in the network. In one embodiment, the storage device 60 and the storage device for storing an index are WORM storage devices.

System 10 can be used either locally or remotely as, for example, a directory in an operating system for organizing files, a database index, a full-text index, or any other data organization method. Data stored in the storage device 60 may be stored, retrieved, or organized via system 10 on server 15 or via system 10 on computer such as computer 25 or computer 30.

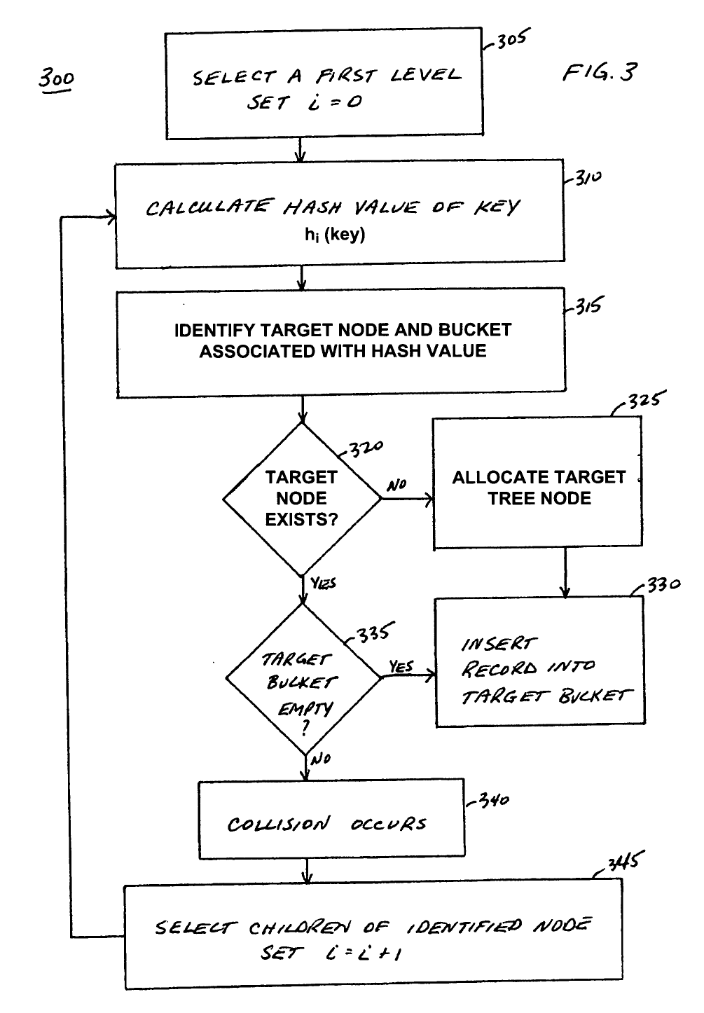

FIG. 2 illustrates a high-level hierarchy of system 10. System 10 includes an index in the form of a tree 205, an insertion module 210, and a retrieval module 215. Tree 205 includes a root node and one or more levels. The insertion module 210 inserts a record into tree 205. In one embodiment, inserting a record into tree 205 means inserting into tree 205 an index entry corresponding to the record. The retrieval module 215 retrieves a record from tree 205 using at least one of the keys of the desired record. Tree 205, the insertion module 210, and the retrieval module 215 may reside on the same computer, on different computers within a local network, or on different computers communicating through a network such as network 35.

Tree 205 is a family of trees uniquely determined by a tuple {M={m₀,m₁,m₂, . . . }, K={k₀,k₁,k₂, . . . }, H={h₀,h₁,h₂, . . . }} where mᵢ denotes a size of a node at level i of tree 205, kᵢ denotes a growth factor at level i of tree 205, hᵢ denotes a hash function at level i of tree 205, and i ε Z*. The hash function h for each level is selected such that each of the hash functions is independent, efficient to calculate, and insensitive to the target range or size of the hash table, r, at a given level. The size of the hash table, r, can be varied at each level of tree 205.

In one embodiment, tree 205 includes a family of universal hash functions as H. In one embodiment, System 10 selects a prime p so that all possible keys are less than p. System 10 defines U as {0, 1, 2, . . . , p−1}. System 10 defines a hash function for a level as
h(x)=((ax+b)mod p)mod r
where a, b ε U, a≈0 and r is the size of the target range of the hash function. {h(x)} has been proven to be universal.

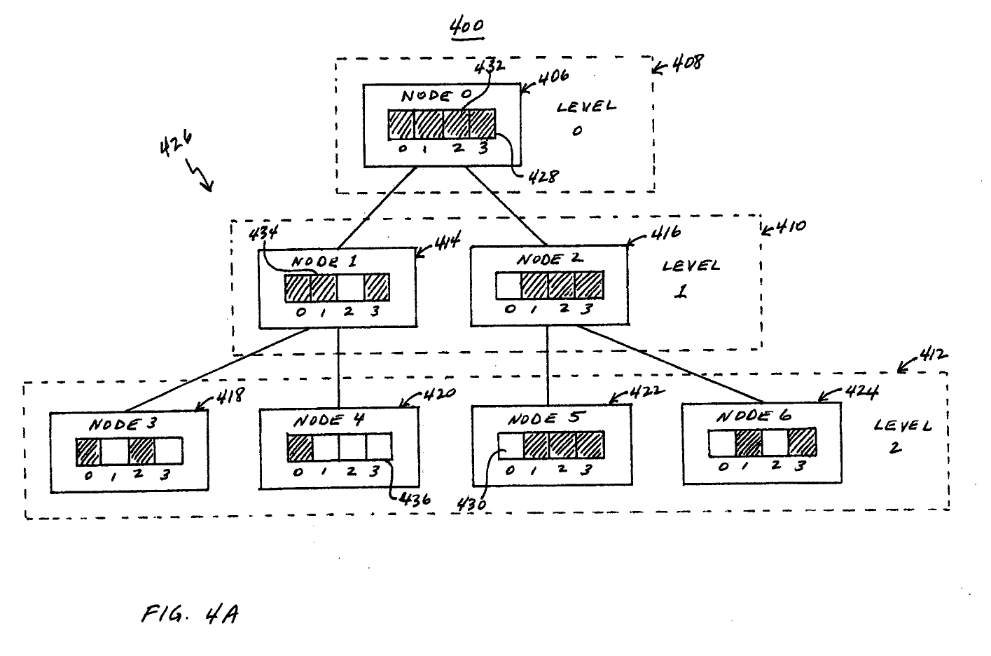

FIG. 3 illustrates a method 300 of the insertion module 210 for inserting a record into tree 205. The insertion module 210 selects a first level in tree 205 (step 305) and sets a level indicator, i, equal to zero. The insertion module 210 calculates a hash value (hᵢ(key)) using a key of the record and a hash function for the selected level (step 310). This hash value serves as an index to a node of tree 205, determining a target bucket at the selected level.

The insertion module 210 identifies a target node and bucket associated with the hash value (step 315). The insertion module 210 determines whether the target node exists (decision step 320). If the target node does not exist, the insertion module 210 allocates the target tree node (step 325) and inserts the record into the target bucket (step 330).

If at decision step 320 the target node exists, the insertion module 210 determines whether the target bucket is empty (decision step 335). If the target bucket is empty, the insertion module 210 inserts the record into the target bucket (step 330). If the target bucket is not empty (decision step 335), a collision occurs at the target bucket (step 340) and the record cannot be inserted in the target bucket. The insertion module 210 selects the children of the target node (step 345), increments the level indicator, i, by one, and repeats steps 310 through 345 until the record is inserted into tree 205.

The insertion module 210 includes an exemplary insertion algorithm summarized as follows in pseudocode with tree 205 denoted as “t”:

```
i [symbol] 0; p [symbol] t.root; index [symbol] h₀(key)
loop
  if node p does not exist then
    p [symbol] allocate a tree node
    p[index] [symbol] x
    return SUCCESS
  end if
  if p[index] is empty then
    p{index} [symbol] x
    return SUCCESS
  end if
  if p[index].key = x.key then
    return FAILURE
  end if
  i [symbol] i + 1 {Go to the next tree level}
  j [symbol] GetNode(i,hᵢ(key))
  p [symbol] p.child[j]
  index [symbol] GetIndex(i,hᵢ(key))
end loop
```

A function GetNode( ) in the insertion algorithm gives a tree node that holds a selected bucket. A function GetIndex( ) in the insertion algorithm returns an index of the selected bucket in the selected tree node. The target range of the hash function, r, (i.e., the size of the hash table at a given level) is determined by a function GetHashTableSize( ). Depending on how these functions are defined, system 10 can realize a family of trees. Table 1 lists exemplary instantiations of these functions for various trees. Table 1: Exemplary trees generated by system 10 for various definitions of GetHashTableSize( ), GetNode( ), and GetIndex( ).

| | GetHashTableSize(i) | GetNode(i,j) | GetIndex(i,j) |
|---|---|---|---|
| Thin Tree (Hash | m (if i = 0); | j div m | j mod m |
| Trie) | m × k (if i ≠ 0) | | |
| Fat Tree | m × kⁱ | j div m | j mod m |
| Multi-Level Hash | m × kⁱ | 0 | j |
| Table | | | |

In general, given a key, the insertion module 210 calculates a target bucket at a selected level by using a corresponding hash function for the selected level. Given a pointer to the root node of tree 205 and a record x, the insertion algorithm returns SUCCESS if the insertion into the target bucket succeeds. The insertion algorithm returns FAILURE if a collision occurs at the target bucket and insertion at the target bucket fails.

Requiring that hash functions at each level be independent reduces a probability that records colliding at one level also collide at a next level. In one embodiment, system 10 dynamically and randomly selects a hash function for each level at run time. Avoiding a fixed hash function for each level reduces vulnerability to an adversary selecting keys that all hash to the same target bucket, causing the tree or index to degenerate into a list. System 10 avoids worst-case behavior in the presence of an adversary and achieves good performance on average, regardless of keys selected by an adversary.

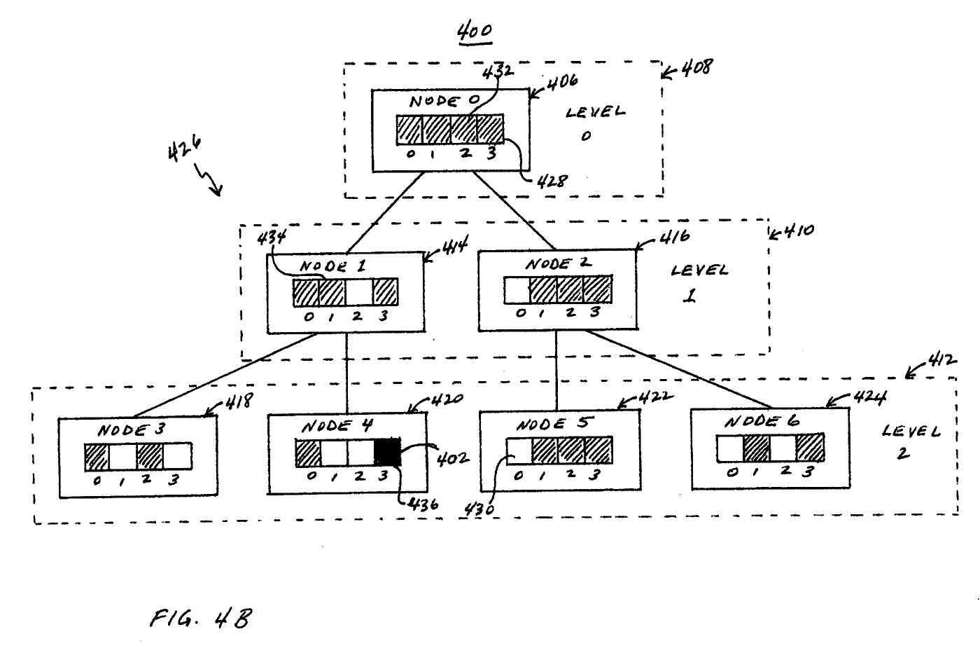

FIG. 4 (FIGS. 4A, 4B, 4C) illustrates insertion of a record in an exemplary tree 400. FIG. 4A illustrates tree 400 before insertion of a record 1, R₁, 402. FIG. 4B illustrates tree 400 after insertion of record 1, R₁, 402, and before insertion of a record 2, R₂, 404. FIG. 4C illustrates tree 400 after insertion of record 2, R₂, 404.

Tree 400 includes a node 0, 406 (a root node of tree 400) at level 0, 408. Tree 400 further includes a level 1, 410, and a level 2, 412. Level 1, 410, includes a node 1, 414, and a node 2, 416. Level 2, 412, includes a node 3, 418, a node 4, 420, a node 5, 422, and a node 6, 424. The root node 406, node 1, 414, node 2, 416, node 3, 418, node 4, 420, node 5, 422, and node 6, 424, are collectively referenced as nodes 426. Node 1, 414, and node 2, 416, are children of node 0, 406. Node 3, 418, and node 4, 420, are children of node 1, 414. Node 5, 422, and node 6, 424, are children of node 2, 416.

The size of each of the nodes 426 is four buckets, i.e., mᵢ=4. The growth factor for tree 400, kᵢ, is 2. In FIG. 4, buckets that are full or occupied by a record such as a bucket 428 are indicated as a filled box. Buckets that are empty or vacant such as a bucket 430 are indicated as an empty or white box. Each of the tree nodes 426 can be designated by a tuple including a level number and a node number on that level: (level number, node number). Numbering for the level numbers starts at zero. Numbering for the nodes on each level starts at zero. Consequently, the node 3, 418, is represented by a tuple (2,0). Each bucket is indicated by a tuple including a level number, a node number on that level, and a bucket number within that node (level number, node number, bucket index number). Numbering for the bucket index starts at zero for each node.

To insert a record R₁, 402, the insertion module 210 selects a first level and sets i=0 (step 305). The insertion module 210 calculates a hash value for a key, key₁, of R₁ 402, using a hash function for level 0, h₀. In this example, h₀(key₁)=2. The value h₀(key₁)=2 corresponds to a bucket at position (0, 0, 2), bucket 432. The insertion module 210 finds that bucket 432 exists (decision step 320) and is full (decision step 335); a collision occurs at bucket 432 (step 330).

The insertion module 210 selects the children of the root node (node 1, 414, and node 2, 416) on level 1, 410 (step 345). The insertion module 210 calculates a hash value for key₁ of R₁ 402, using a hash function for level 1, h₁. In this example, h₁(key₁)=1. The value h₁(key₁)=1 corresponds to a bucket at position (1, 0, 1), bucket 434. The insertion module 210 finds that bucket 434 exists (decision step 320) and is full (decision step 335); a collision occurs at bucket 434 (step 330).

The insertion module 210 selects the children of node 1, 414 (node 3, 418, and node 4, 420) on level 2, 412 (step 345). The insertion module 210 calculates a hash value for key₁ of R₁ 402, using a hash function for level 2, h₂. In this example, h₂(key₁)=7. The value h₂(key₁)=7 corresponds to a bucket at position (2, 1, 3), bucket 436 (bucket 436 is the bucket at overall position 7 in the children nodes of node 1, 414, counting from 0). The insertion module 210 finds that bucket 434 exists (decision step 320) and is empty (decision step 335). The insertion module 210 inserts R₁ 402 in bucket 436, as indicated by the black square at bucket 436 in FIG. 4B.

To insert a record, R₂ 404, the insertion module 210 selects a first level and sets i=0 (step 305). The insertion module 210 calculates a hash value for a key, key₂, of R₂ 402, using a hash function for level 0: h₀. In this example, h₀(key₂)=1. The value h₀(key₂)=1 corresponds to a bucket at position (0, 0, 1), bucket 438. The insertion module 210 finds that bucket 438 exists (decision step 320) and is full (decision step 335); a collision occurs at bucket 438 (step 330).

The insertion module 210 selects the children of the root node (node 1, 414, and node 2, 416) on level 1, 410 (step 345). The insertion module 210 calculates a hash value for key₂ of R₂ 404, using a hash function for level 1, h₁. In this example, h₁(key₂)=6. The value h₁(key₂)=6 corresponds to a bucket at position (1, 1, 2), bucket 440 (bucket 440 is the bucket at overall position 6 in the children nodes of node 0, 406, counting from 0). The insertion module 210 finds that bucket 440 exists (decision step 320) and is full (decision step 335); a collision occurs at bucket 434 (step 330).

The insertion module 210 selects the children of node 2, 416 (node 5, 422, and node 6, 424) on level 2, 412 (step 345). The insertion module 210 calculates a hash value for key₂ of R₂ 404, using a hash function for level 2, h₂. In this example, h₂(key₂)=3. The value h₂(key₂)=3 corresponds to a bucket at position (2, 2, 3), bucket 442. The insertion module 210 finds that bucket 442 exists (decision step 320) and is full (decision step 335); a collision occurs at bucket 442 (step 330).

A new level in tree 400 is required because a collision has occurred at all the existing levels of the tree—level 0, 408, level 1, 410, and level 2, 412. The insertion module 210 selects a hash function as h₃ from a universal set by randomly selecting numbers for variables a and b, and setting r to be the hash table size; in this example, r is set equal to 8. The insertion module 210 calculates a hash value for key₂ of R₂ 404, using the selected hash function for a level 3, 444, h₃. In this example, h₃(key₂)=3. The target bucket (3, 4, 3) is located in bucket 3 of a child of node 5, 422, at node position (3, 4). The insertion module 210 allocates the desired tree node, node 7, 446, in level 3, 444. The insertion module 210 inserts R₂ 404 into bucket 448, as indicated by the black square at bucket 448 in FIG. 4C.

Once a record is inserted in tree 205, the location of the record in the tree is never changed. The path to the record, i.e., the sequence of tree nodes beginning at the root that are traversed to locate the record, is also never changed.

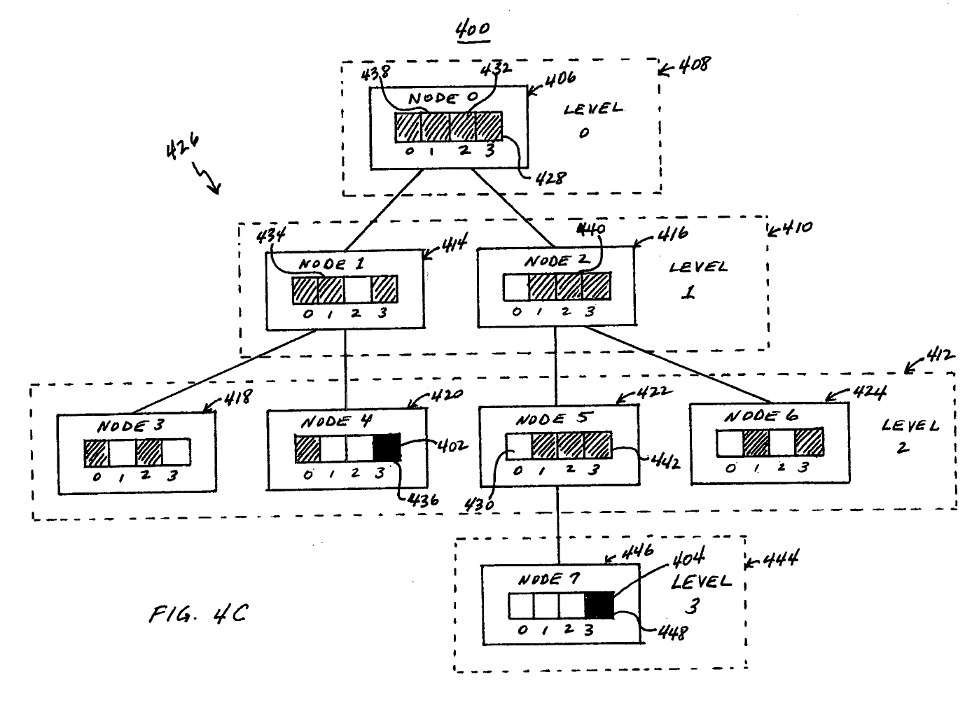

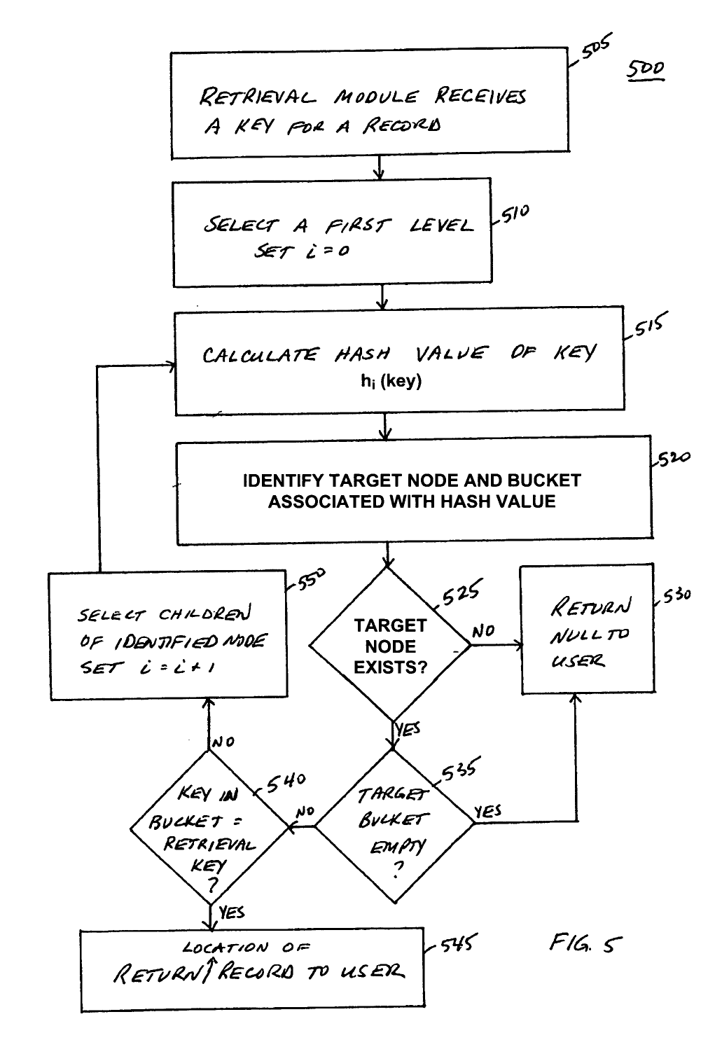

FIG. 5 illustrates a method 500 of the retrieval module 215 in retrieving a record that has been inserted in tree 205. The retrieval module 215 receives a key from system 210 for a record a user wishes to retrieve (step 505) (referenced herein as a retrieval key and a search record). The retrieval module 215 selects a first level in tree 205 (step 510) and sets a level indicator, i, equal to zero. The retrieval module 215 calculates a hash value (hᵢ(key)) using the retrieval key and a hash function for the selected level (step 515). This hash value serves as an index to a node of tree 205, determining a target bucket at the selected level.

The retrieval module 215 identifies a target node and bucket associated with the hash value (step 520). The retrieval module 215 determines whether the target node exists (decision step 525). If the target node does not exist, the search record has not been stored in the tree 205 and the retrieval module 215 returns a NULL to the user (step 530).

If at decision step 525 a target node exists, the retrieval module 215 determines whether the target bucket is empty (decision step 535). If the target bucket is empty, the search record has not been stored in the tree 205 and the retrieval module 215 returns a NULL to the user (step 530). If the target bucket is not empty (decision step 535), the retrieval module 215 compares the key stored in the target bucket with the retrieval key. If the retrieval key matches the stored key (decision step 540), the retrieval module 215 returns a value indicating a location of the search record (step 545). If the search record is stored in tree 205, the retrieval module returns the search record.

If the retrieval key does not match the stored key, the retrieval module 215 selects the children of the selected node on a next level (step 550) and increments the level indicator, i, by one. The retrieval module 215 repeats steps 515 through 550 until the record is found or until NULL is returned to the user.

The retrieval module 215 includes an exemplary insertion algorithm summarized as follows in pseudocode with tree 205 denoted as “t”:

```
i [symbol] 0; p [symbol] t.root; index [symbol] h₀(key)
loop
  if node p does not exist then
    return NULL
  end if
  if p[index] is empty then
    return NULL
  end if
  if p[index].key = x.key then
    return p[index]
  end if
  i [symbol] i + 1 {Go to the next tree level}
  j [symbol] GetNode(i,hᵢ(key))
  p [symbol] p.child[j]
  index [symbol] GetIndex(i,hᵢ(key))
end loop
```

The present system represents a family of hash trees. By varying parameters and choosing different hash functions, the present system produces trees with different characteristics. Exemplary trees of the present system include a thin tree, a hash trie, a fat tree, and a multi-level hash table.

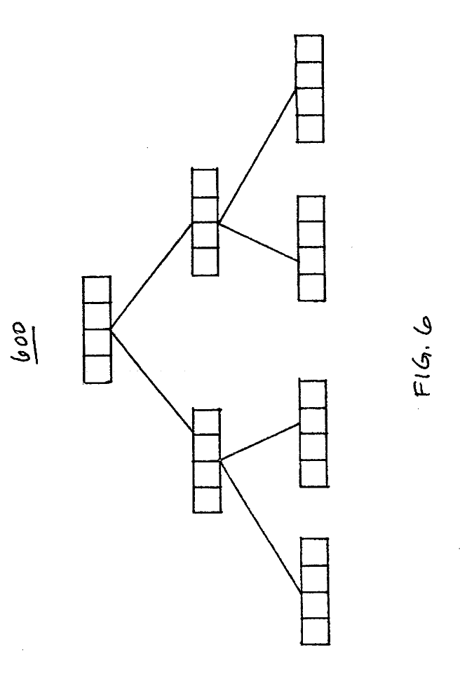

A thin tree is a standard tree in which each node has a fixed size and a fixed number of children nodes. FIG. 6 illustrates an exemplary thin tree 600 with mᵢ=4 and kᵢ=2 for all levels i. In simpler terms, m=4 and k=2; each node has m buckets and k pointers to children of a node.

By using hash functions that are independent and uniform, a new record is equally likely to follow any path from the root to a leaf node. Consequently, the thin tree tends to grow from the root down to the leaves in a balanced fashion, meaning that the tree depth and the retrieval time are logarithmic in the number of records in the tree. A tree node is allocated only as needed for record insertion. Consequently, each node includes at least one record and System 10 includes a thin tree that exhibits a linearly bounded space cost.

A hash trie is a special case of a thin tree in which the values for m and k are equivalent and a power of 2, and the hash function at each level selects a subsequence of the bits in a key. To insert a record into a hash trie, system 10 first hashes a key of the record. For example, if the size of a trie node is 256 buckets and a branch factor is 256, system 10 hashes the key into a 64-bit hash value. In one embodiment, system 10 uses a cryptographic hash function such as, for example, SHA-1, to hash the key to minimize the chances of collisions and vulnerability to a worst-case attack by an adversary.

At each level, the hash trie uses 8 bits of the hash value as an index. If no collision occurs during insertion of a record in a level, the record is inserted. If a collision occurs, system 10 accesses a sub-trie pointed to by the index and uses the next 8 bits as a new index.

The exemplary trie discussed above is a thin tree in which m=k=256. System 10 constructs the “hash functions” as follows: at a first level, use the first 8 bits as a hash value; at a next level, use bits 0 through 15 as a hash value; at a following level, use bits 8 through 24 as a hash value, etc.

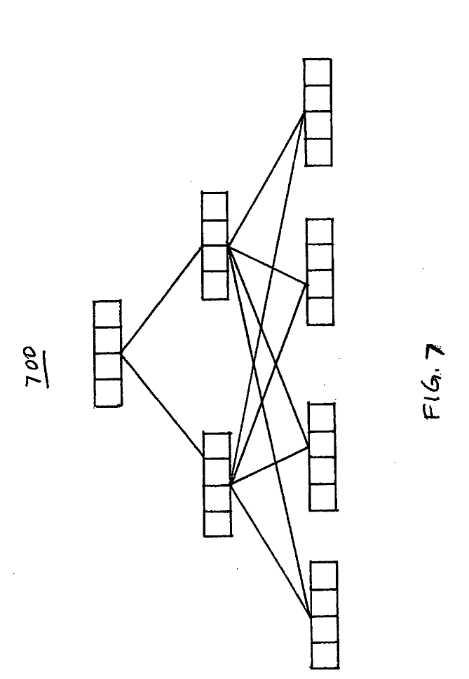

A fat tree is a hash tree in which each node includes more than one parent. A fatness characteristic of the fat tree indicates how many parents each node may have. FIG. 7 illustrates an exemplary fully fat tree 700 in which all the nodes in the upper level are parents, m=4, and k=2. The fully fat tree 700 is presented as a simple example of a fat tree. The hash table size, r, of a fully fat tree is m x kⁱ for each level i, where i ε Z*. Therefore, when a collision occurs, the record can be inserted into any node at the next level, not just the children nodes.

By using hash functions that are independent and uniform, a new record is equally likely to follow any path from the root to a leaf node. Consequently, as is the case for a thin tree, a fat tree tends to grow from the root down to the leaves in a balanced fashion. Compared to the thin tree, a fat tree exhibits a higher tolerance toward non-uniformity in hash functions because a fat tree includes more candidate buckets at each level.

Hashing at a level in a thin tree depends on a node in which a collision occurred in an upper level; consequently children nodes form a hash table to be inserted. In comparison, hashing at each level in a fat tree is independent. If each level of a fat tree is located in a different disk, system 10 can access these levels in parallel using their corresponding hash functions. Consequently, any retrieval of records can be accomplished with only one disk access time.

Independency among levels in a fat tree improves reliability of system 10. A fail to read in an upper level of tree 205 does not affect index entries in a lower level.

At each level in a fat tree, the number of children nodes associated with a node increases exponentially. The space required to maintain the children pointers for each node is expensive. Rather than maintain pointers to children nodes for each node, in one embodiment, system 10 maintains an extra array for each level to track whether a tree node is allocated and if so, the location of the allocated tree node.

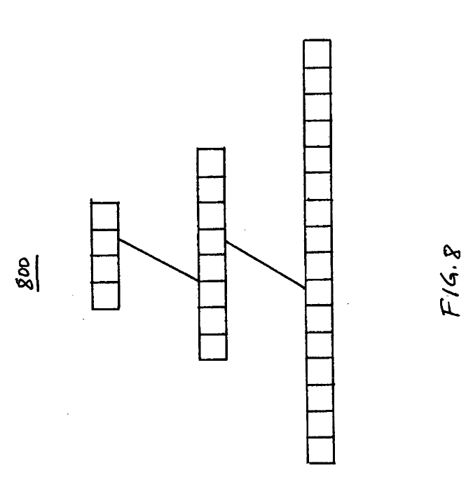

FIG. 8 illustrates an exemplary multi-level hash table 800. For a multi-level hash table, mᵢ=m×kⁱ where m is the size of the root node and i is the level in the tree. The multi-level hash table 800 has a growth factor, k, of 2. It includes a tree in which the tree node at each level is twice the size of the tree node in the previous level. For simplicity, m=4 is used to denote the structure of the multi-level hash table 800.

A multi-level hash table has a tree depth similar to a corresponding fat tree for a given insertion sequence and set of hash functions. Access to a multi-level hash table can be parallelized in a manner similar to that of a fat tree.

In one embodiment, system 10 improves space utilization while maintaining logarithmic tree depth and retrieval time by performing linear probing within a tree node. When a collision occurs in a node, system 10 linearly searches other buckets within the node before probing a next level in the tree 205. More specifically, at each level i, system 10 uses the following series of hash functions:
hᵢ(j, key)=(hᵢ(key)+j)mod m
where j=1, 2, . . . , m−1. For a multi-level hash table, system 10 introduces a “virtual node”. A single tree node at each level is divided into fixed-size virtual nodes. System 10 then probes linearly within the virtual nodes. In yet another embodiment, hash table optimizations such as, for example, double hashing are applied to the hash tree.

If the tree node is small, the number of buckets in the first few layers in tree 205 is small. Those buckets quickly fill when the number of records contained in tree 205 is large. Consequently, system 10 traverses the upper few layers each time a record is inserted and most of the time when a record is retrieved, incurring an unnecessary processing and time cost. In one embodiment, the first-level hash table is configured to include a number of tree nodes such that the first few upper tree levels are effectively removed from the hash tree. In this embodiment, the size of the first-level hash table is configured large enough to allow efficient insertion and retrieval in tree 205 but small enough to avoid over-provisioning.

Many important records have an expiration date after which the records are to be disposed. Disposition of records includes deleting the records. In some cases, disposition of records includes ensuring that the records cannot be recovered or discovered even with the use of data forensics. Such disposition is commonly referred to as shredding and can be achieved, for example, by physical destruction of the storage. For disk-based WORM storage, an alternative method of shredding is to overwrite the record more than once with specific patterns so as to completely erase remnant magnetic effects that may otherwise enable the record to be recovered through techniques such as, for example, magnetic scanning tunneling microscopy.

To prevent reconstruction of records that have been disposed, index entries pointing to the records also require disposition. However, the smallest unit of disposition (e.g., sector, object, disc) is typically larger than an index entry. In one embodiment, each record includes an expiration date. As the insertion module 210 inserts a record in tree 205, an index entry associated with the record is stored in a disposition unit together with index entries associated with records having similar or equivalent expiration dates. As the records expire and are disposed, the disposition unit is disposed, thereby allowing disposition of only those index entries associated with the disposed records.

For example, the hash function at each level may identify a set of candidate buckets in several disposition units. The insertion module 210 selects the target bucket from among the set of candidate buckets based on the expiration dates of records included in the disposition units. If the target bucket is occupied, the insertion module 210 has the option to select another target bucket from the candidate set. To retrieve a record, the retrieval module 215 determines whether the record exists in any of the candidate buckets.

In one embodiment, an expiration date is associated with each disposition unit. The expiration date can be extended but not shortened. A disposition unit can be disposed only after its expiration date. In such an embodiment, the expiration date of a disposition unit containing index entries is set to the latest expiration date of the records corresponding to the index entries.

While the present invention has been described with the assumption that there are no duplicate record keys, it should be apparent to one skilled in the art that the invention can be readily adapted to handle situations where there are multiple records with the same key. It should further be apparent that a bucket may contain more than one record or index entry. It should also be clear that WORM storage refers generally to storage that does not allow stored data to be modified, and may take several forms including WORM storage systems that are based on rewritable magnetic disks and those that do not allow stored data to be modified for a specified period of time after the data is written.

It is to be understood that the specific embodiments of the invention that have been described are merely illustrative of certain applications of the principle of the present invention. Numerous modifications may be made to the system, service, and method for organizing data for fast retrieval described herein without departing from the spirit and scope of the present invention.

What is claimed is:

1. A method of organizing data, comprising:
obtaining a key for a record;
performing a hash function on the key to generate a hash value indicative of a candidate position at which to insert the record in a tree;
determining if the candidate position is available in the tree;
performing at least one additional hash function on the key to generate at least one additional hash value indicative of at least one additional candidate position if the position is not available;
determining if the at least one additional candidate position is available;
creating a new node including a candidate position in the tree if the at least one additional candidate position is not available; and
assigning the record to an available candidate position.

2. The method according to claim 1, wherein the hash value is indicative of a candidate position in a first level of the tree; and
wherein subsequent hash values are indicative of candidate positions in corresponding subsequent levels of the tree.

3. The method according to claim 1, wherein the position in the tree to which a record is assigned, is immutable.

4. The method according to claim 1, wherein if the at least one additional candidate position is not available, conducting a linear probe of a level on which the at least one additional candidate position is located in order to locate an available position.

5. The method according to claim 1, wherein at least one of the hash function and the additional hash function are universal.

6. The method according to claim 1, wherein the sequence of the hash function and the additional hash function are immutable.

7. The method according to claim 1, wherein at least the first two levels of the tree are collapsed into a single level that includes a hash table, to facilitate access to a position in the tree.

8. The method according to claim 1, wherein the tree is stored in a write-once read-many storage.

9. The method according to claim 1, wherein the candidate position is determined by an expiration date of the record, and wherein the hash value is generated by performing a hash function on the key.

10. The method of claim 1, further comprising:
obtaining a retrieval key;
performing a retrieval hash function on the retrieval key to generate a retrieval hash value indicative of a retrieval candidate position to find a desired record with the retrieval key in the tree;
determining if the desired record is in the retrieval candidate position;
returning the desired record if the desired record is in the retrieval candidate position;
performing at least one additional retrieval hash function on the retrieval key to generate at least one additional retrieval hash value indicative of at least one additional retrieval candidate position if the desired record is not in the retrieval candidate position;
determining if the desired record is in the at least one additional retrieval candidate position;
returning the desired record if the desired record is in the at least one additional retrieval candidate position; and
indicating that a record with the retrieval key does not exist in the tree if the desired record is not in the at least one additional candidate position.

11. The method according to claim 10, wherein a path to the desired record in the tree, as defined by a sequence of retrieval candidate positions where the desired record could be found, is immutable.

12. A computer program product including a plurality of executable instruction codes on a computer-readable medium, for organizing data, comprising:
a first set of instruction codes for obtaining a key for a record;
a second set of instruction codes for performing a hash function on the key to generate a hash value indicative of a candidate position at which to insert the record in a tree;
a third set of instruction codes for determining if the candidate position is available in the tree; performing at least one additional hash function on the key to generate at least one additional hash value indicative of at least one additional candidate position if the position is not available;
a fourth set of instruction codes for determining if the at least one additional candidate position is available;
a fifth set of instruction codes for creating a new node including a candidate position in the tree if the at least one additional candidate position is not available; and
a sixth set of instruction codes for assigning the record to an available candidate position.

13. The computer program product according to claim 12, wherein the hash value is indicative of a candidate position in a first level of the tree; and
wherein subsequent hash values are indicative of candidate positions in corresponding subsequent levels of the tree.

14. The computer program product according to claim 12, wherein the position in the tree to which a record is assigned, is immutable.

15. The computer program product according to claim 12, wherein if the at least one additional candidate position is not available, a seventh set of instruction codes conducts a linear probe of a level on which the at least one additional candidate position is located in order to locate an available position.

16. The computer program product of claim 12, further comprising:
an eight set of instruction codes for obtaining a retrieval key;
a ninth set of instruction codes for performing a retrieval hash function on the retrieval key to generate a retrieval hash value indicative of a retrieval candidate position to find a desired record with the retrieval key in the tree;
a tenth set of instruction codes for determining if the desired record is in the retrieval candidate position;
an eleventh set of instruction codes for returning the desired record if the desired record is in the retrieval candidate position;
a twelfth set of instruction codes for performing at least one additional retrieval hash function on the retrieval key to generate at least one additional retrieval hash value indicative of at least one additional retrieval candidate position if the desired record is not in the retrieval candidate position;
a thirteenth set of instruction codes for determining if the desired record is in the at least one additional retrieval candidate position;
a fourteenth set of instruction codes for returning the desired record if the desired record is in the at least one additional retrieval candidate position; and
a fifteenth set of instruction codes for indicating that a record with the retrieval key does not exist in the tree if the desired record is not in the at least one additional candidate position.

17. A system for organizing data, comprising:
an insertion module for obtaining a key for a record;
the insertion module performing a hash function on the key to generate a hash value indicative of a candidate position at which to insert the record in a tree;
the insertion module determining if the candidate position is available in the tree; performing at least one additional hash function on the key to generate at least one additional hash value indicative of at least one additional candidate position if the position is not available;
the insertion module determining if the at least one additional candidate position is available;
the insertion module creating a new node including a candidate position in the tree if the at least one additional candidate position is not available; and
the insertion module assigning the record to an available candidate position.

18. The system according to claim 17, wherein the hash value is indicative of a candidate position in a first level of the tree; and
wherein subsequent hash values are indicative of candidate positions in corresponding subsequent levels of the tree.

19. The system according to claim 17, wherein the position in the tree to which a record is assigned, is immutable.

20. The method of claim 17, further comprising:
a retrieval module for obtaining a retrieval key;
the retrieval module performing a retrieval hash function on the retrieval key to generate a retrieval hash value indicative of a retrieval candidate position to find a desired record with the retrieval key in the tree;
the retrieval module determining if the desired record is in the retrieval candidate position;
the retrieval module returning the desired record if the desired record is in the retrieval candidate position;
the retrieval module performing at least one additional retrieval hash function on the retrieval key to generate at least one additional retrieval hash value indicative of at least one additional retrieval candidate position if the desired record is not in the retrieval candidate position;
the retrieval module determining if the desired record is in the at least one additional retrieval candidate position;
the retrieval module returning the desired record if the desired record is in the at least one additional retrieval candidate position; and
the retrieval module indicating that a record with the retrieval key does not exist in the tree if the desired record is not in the at least one additional candidate position.
